(19) United States
(12) Patent Application Publication
(10) Pub. No.: US 2025/0306637 A1
(43) Pub. Date: Oct. 2, 2025

(54) ELECTRONIC DEVICE

(71) Applicant: VIVO MOBILE COMMUNICATION CO., LTD., Dongguan (CN)

(72) Inventor: Ling HU, Dongguan (CN)

(73) Assignee: VIVO MOBILE COMMUNICATION CO., LTD., Dongguan (CN)

(21) Appl. No.: 19/236,973

(22) Filed: Jun. 12, 2025

Related U.S. Application Data
(63) Continuation of application No. PCT/CN2023/137555, filed on Dec. 8, 2023.

(30) Foreign Application Priority Data
Dec. 13, 2022 (CN) 202211600522.6

(51) Int. Cl. G06F 1/16; G06V 40/13

(52) U.S. Cl. CPC G06F 1/1643; G06F 1/1652; G06F 1/1656; G06V 40/1306

(57) ABSTRACT

An electronic device is provided. The electronic device includes a flexible screen, a support plate, and an ultrasonic fingerprint module. The support plate is disposed on an inner side of the flexible screen. The support plate includes a first carbon fiber layer, a second carbon fiber layer, and a third carbon fiber layer that are stacked. Both extension directions of carbon fibers in the first carbon fiber layer and carbon fibers in the third carbon fiber layer are perpendicular to an extension direction of carbon fibers in the second carbon fiber layer. The ultrasonic fingerprint module is disposed on one side of the support plate away from the flexible screen.

### CROSS-REFERENCE TO RELATED APPLICATIONS

This application is a continuation of International Application No. PCT/CN2023/137555, filed on Dec. 8, 2023, which claims priority to Chinese Patent Application No. 202211600522.6, filed on Dec. 13, 2022. The entire contents of each of the above-referenced applications are expressly incorporated herein by reference.

### TECHNICAL FIELD

This application pertains to the technical field of flexible screen devices, and specifically, relates to an electronic device.

### BACKGROUND

In a related technology, with continuous development of mobile electronic devices, foldable electronic devices gradually come into users' view. To facilitate folding of the electronic devices, displays of the foldable electronic devices are usually flexible screens. A steel plate may be disposed on an inner side of the flexible screen to support the flexible screen, to ensure structural integrity of the flexible screen after frequent bending.

To facilitate use of the electronic devices, increasingly more screen fingerprint recognition technologies are applied to the electronic devices. Ultrasonic fingerprint recognition is used as an example. Because of penetrability of an ultrasonic wave, unlocking of an electronic device can be quickly implemented. However, because support structures such as a conventional steel plate increase acoustic resistance to ultrasonic waves, a recognition rate of ultrasonic fingerprint recognition is low, and recognition efficiency of unlocking the electronic devices is affected.

### SUMMARY

An embodiment of this application provides an electronic device, including:
a flexible screen;
a support plate, where the support plate is disposed on an inner side of the flexible screen, the support plate includes a first carbon fiber layer, a second carbon fiber layer, and a third carbon fiber layer that are stacked, and both extension directions of carbon fibers in the first carbon fiber layer and carbon fibers in the third carbon fiber layer are perpendicular to an extension direction of carbon fibers in the second carbon fiber layer; and
an ultrasonic fingerprint module, where the ultrasonic fingerprint module is disposed on one side of the support plate away from the flexible screen.

In this application, an electronic device is provided. The electronic device includes a flexible screen, a support plate, and an ultrasonic fingerprint module. The support plate is disposed on the inner side of the flexible screen. The support plate includes a first carbon fiber layer, a second carbon fiber layer, and a third carbon fiber layer that are stacked. Both the extension directions of the carbon fibers in the first carbon fiber layer and the carbon fibers in the third carbon fiber layer are perpendicular to the extension direction of the carbon fibers in the second carbon fiber layer, so that an alternately stacked design of the sandwich-type support plate can optimize a phase difference of acoustic impedance, thereby improving acoustic wave propagation performance of the support plate, and improving recognition efficiency of unlocking the electronic device.

Additional aspects and advantages of this application will become clear from the following description, or will be learned from the practice of this application.

### BRIEF DESCRIPTION OF DRAWINGS

The above-mentioned and/or additional aspects and advantages of this application become clear and easy to understand from the description of embodiments in conjunction with the following accompanying drawings.

FIG. 1 is a cross-sectional view of a local part of an electronic device according to an embodiment of this application;

FIG. 2 is a sectional view 1 of a local part of an electronic device according to an embodiment of this application;

FIG. 3 is a schematic diagram of carbon fiber extension in a support plate of an electronic device according to an embodiment of this application;

FIG. 4 is a schematic diagram 1 of fitting between a support plate and a conductive structure of an electronic device according to an embodiment of this application;

FIG. 5 is a schematic diagram 2 of fitting between a support plate and a conductive structure of an electronic device according to an embodiment of this application;

FIG. 6 is a schematic diagram of a local part of a support plate of an electronic device according to an embodiment of this application;

FIG. 7 is a sectional view 2 of a local part of an electronic device according to an embodiment of this application;

FIG. 8 is a sectional view 3 of a local part of an electronic device according to an embodiment of this application; and

FIG. 9 is a sectional view 4 of a local part of an electronic device according to an embodiment of this application.

### REFERENCE NUMERALS

1. Flexible screen; 2. Support plate; 21. First carbon fiber layer; 22. Second carbon fiber layer; 23. Third carbon fiber layer; 24. First through hole region; 3. Ultrasonic fingerprint module; 4. Conductive structure; 5. Metal layer; 51. Hollowed region; 52. Hole channel; and 6. Adhesive layer.

### DETAILED DESCRIPTION

The following describes the technical solutions in embodiments of this application with reference to the accompanying drawings in embodiments of this application. It is clear that the described embodiments are some rather than all embodiments of this application. All other embodiments obtained by a person of ordinary skill in the art based on embodiments of this application without involving creative efforts shall fall within the protection scope of this application.

Features of the terms “first” and “second” in the specification and claims of this application may explicitly or implicitly include one or more such features. In the description of the present disclosure, unless otherwise described, “a plurality of” means two or more. In addition, in the specification and claims, “and/or” represents at least one of connected objects, and the character “/” usually represents an “or” relationship between the associated objects.

In the descriptions of the present disclosure, it should be noted that, unless otherwise specified and limited, the terms “mount”, “communicate”, and “connect” should be understood in a broad sense, for example, may be a fixed connection, a detachable connection, or an integrated connection, may be a mechanical connection or an electrical connection, may be a direct connection or an indirect connection by using an intermediate medium, or may be communication between two elements. A person of ordinary skill in the art can understand specific meanings of the foregoing terms in the present disclosure based on a specific situation.

It should be understood that “an embodiment” or “one embodiment” mentioned in the entire specification means that particular features, structures, or characteristics related to the embodiment are included in at least one embodiment of this application. Therefore, “in an embodiment” or “in one embodiment” appearing throughout the specification does not necessarily indicate a same embodiment. In addition, these particular features, structures, or characteristics may be combined in one or more embodiments in any appropriate manner.

Many specific details are described in the following description to fully understand this application. However, this application may be implemented in another manner different from that described herein. Therefore, the protection scope of this application is not limited to the specific embodiments disclosed below.

An electronic device provided in embodiments of this application may be a device that has a photographing requirement, for example, a mobile phone, a pad, a camera, a camcorder, or a notebook computer.

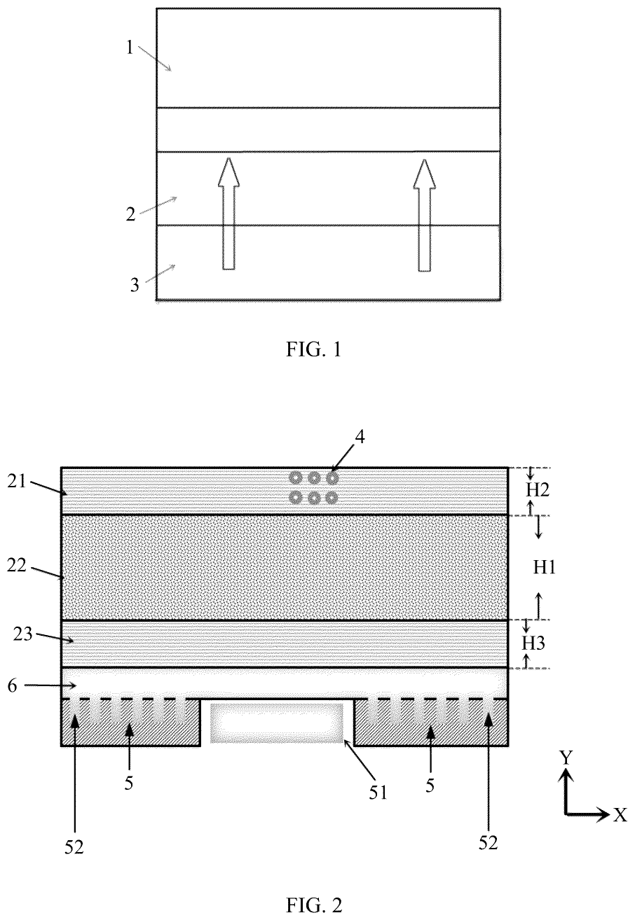

The following describes an electronic device according to embodiments of this application with reference to FIG. 1 to FIG. 9.

As shown in FIG. 1 and FIG. 2, according to some embodiments of this application, an electronic device is provided. The electronic device includes:
a flexible screen 1, a support plate 2, and an ultrasonic fingerprint module 3. The electronic device may be a foldable electronic device. To ensure a display effect of the electronic device when the electronic device is unfolded and folded, image display of the electronic device in different states may be implemented by using an unfolded state and a folded state of the flexible screen 1.

Referring to FIG. 1 and FIG. 2, the support plate 2 is disposed on an inner side of the flexible screen 1. For example, the support plate 2 is adhered to the inner side of the flexible screen 1 by using an adhesive material. The support plate 2 includes a first carbon fiber layer 21, a second carbon fiber layer 22, and a third carbon fiber layer 23 that are sequentially stacked. The second carbon fiber layer 22 is sandwiched between the first carbon fiber layer 21 and the third carbon fiber layer 23, and both an extension direction of carbon fibers in the first carbon fiber layer 21 and an extension direction of carbon fibers in the third carbon fiber layer 23 are perpendicular to an extension direction of carbon fibers in the second carbon fiber layer 22.

Referring to FIG. 1, the ultrasonic fingerprint module 3 is disposed on one side of the support plate 2 away from the flexible screen 1. The ultrasonic fingerprint module 3 may emit an ultrasonic wave of a specific frequency toward the side of the flexible screen 1, scan a fingerprint of a finger of a user by using the ultrasonic wave, and establish a 3D image of the fingerprint by using different reflection effects of the ultrasonic wave at different locations of the fingerprint, to unlock the electronic device by recognizing the fingerprint of the user.

For example, the first carbon fiber layer 21 may be a layer in the support plate 2 close to the flexible screen 1, the third carbon fiber layer 23 may be a layer in the support plate 2 away from the flexible screen 1, and the carbon fibers in the first carbon fiber layer 21, the second carbon fiber layer 22, and the third carbon fiber layer 23 may all extend along planes in which the carbon fiber layers are located. In a case that the extension direction of the carbon fibers in the first carbon fiber layer 21 is parallel to the extension direction of the carbon fibers in the third carbon fiber layer 23, the extension directions of the carbon fibers in the first carbon fiber layer 21 and the carbon fibers in the third carbon fiber layer 23 may be perpendicular to the extension direction of the carbon fibers in the second carbon fiber layer 22. In some embodiments, in a case that the extension direction of the carbon fibers in the first carbon fiber layer 21 intersects the extension direction of the carbon fibers in the third carbon fiber layer 23, the extension directions of the carbon fibers in the first carbon fiber layer 21 and the carbon fibers in the third carbon fiber layer 23 may be perpendicular to the extension direction of the carbon fibers in the second carbon fiber layer 22. Therefore, it can be ensured that both the extension directions of the carbon fibers in the first carbon fiber layer 21 and the carbon fibers in the third carbon fiber layer 23 are perpendicular to the extension direction of the carbon fibers in the second carbon fiber layer 22.

In addition, through simulation and analysis on the support plate 2 of the three-layer structure, an alternately stacked design of the sandwich-type support plate 2 can optimize a phase difference of acoustic impedance, thereby improving acoustic wave propagation performance of the support plate 2, and improving recognition efficiency of unlocking the electronic device.

In addition, the support plate 2 may, for example, be of a structure including four, five, or more carbon fiber layers, and extension directions of carbon fibers in adjacent layers are perpendicular to each other. Therefore, on a basis of ensuring a thickness of the support plate 2, uniformity of acoustic wave transmission in the support plate 2 can be improved.

For example, referring to FIG. 2, a sum of a thickness H2 of the first carbon fiber layer 21 and a thickness H3 of the third carbon fiber layer 23 is equal to a thickness H1 of the second carbon fiber layer 22.

For example, because an acoustic wave propagates in all directions of the support plate 2, when the sum of the thicknesses of the first carbon fiber layer 21 and the third carbon fiber layer 23 that have the same carbon fiber extension direction is equal to the thickness of the second carbon fiber layer 22, a phase difference offset of the acoustic wave in the support plate 2 may be reduced, thereby improving propagation efficiency of the acoustic wave in the support plate 2.

In addition, the thickness of the first carbon fiber layer 21 may be equal to the thickness of the third carbon fiber layer 23, or the thickness of the first carbon fiber layer 21 may be different from the thickness of the third carbon fiber layer 23, provided that the sum of the thickness of the first carbon fiber layer 21 and the thickness of the third carbon fiber layer 23 is equal to the thickness of the second carbon fiber layer 22.

A thickness range of the support plate 2 may be 120 μm to 180 μm, a thickness range of the second carbon fiber layer 22 may be 60 μm to 90 μm, and both of thickness ranges of the first carbon fiber layer 21 and the third carbon fiber layer 23 may be 30 μm to 45 μm. For example, in a case that the thickness of the support plate 2 is 150 μm, the thickness of the second carbon fiber layer 22 may be 75 μm, and both the thickness of the first carbon fiber layer 21 and the thickness of the third carbon fiber layer 23 may be 37.5 μm.

For example, the extension direction of the carbon fibers in the first carbon fiber layer 21 is parallel to the extension direction of the carbon fibers in the third carbon fiber layer 23.

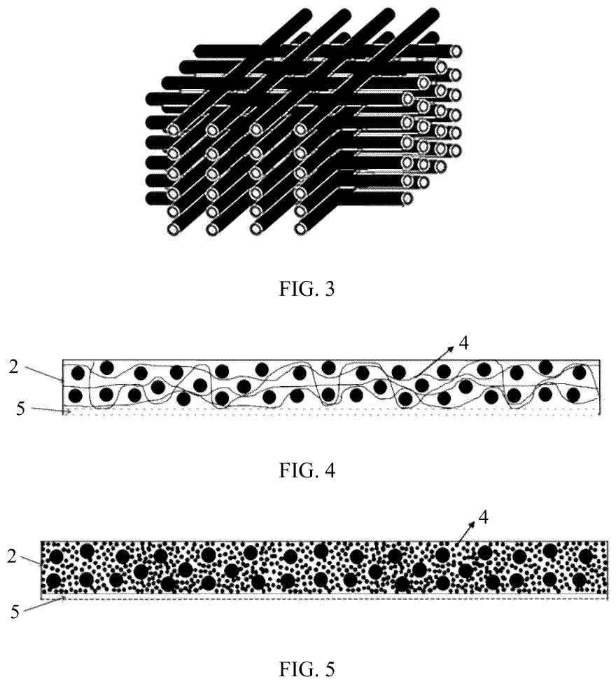

For example, referring to FIG. 2 and FIG. 3, both the extension directions of the carbon fibers in the first carbon fiber layer 21 and the carbon fibers in the third carbon fiber layer 23 may be parallel to an X direction in FIG. 2. In addition, the extension direction of the carbon fibers in the second carbon fiber layer 22 may be a direction perpendicular to an X-Y plane in FIG. 2. In this way, a structure of alternately stacked carbon fibers arranged as 0°-90°-0° (included angles with an X-axis direction) or a structure of alternately stacked carbon fibers arranged as 90°-0°-90° (included angles with an X-axis direction) is formed in the support plate 2, to ensure that both the extension directions of the carbon fibers in the first carbon fiber layer 21 and the carbon fibers in the third carbon fiber layer 23 are perpendicular to the extension direction of the carbon fibers in the second carbon fiber layer 22.

For example, referring to FIG. 4 and FIG. 5, the electronic device further includes conductive structures 4, and the conductive structures 4 are embedded in at least one of the first carbon fiber layer 21, the second carbon fiber layer 22, or the third carbon fiber layer 23.

For example, the conductive structures 4 may be conductive particles, for example, aluminum particles, copper particles, or silver particles; or the conductive structures 4 are conductive fibers, for example, copper fibers or silver fibers. The conductive structures 4 may be evenly distributed in one of the first carbon fiber layer 21, the second carbon fiber layer 22, and the third carbon fiber layer 23, the conductive structures 4 may be evenly distributed in any two layers separately, or the conductive structures 4 may be distributed in all the three layers. In addition, the conductive structures 4 in the three layers may be all conductive particles, all conductive fibers, or a combination of conductive particles and conductive fibers. For example, the combination of conductive particles and conductive fibers refers to a combination of conductive particles and conductive fibers in each layer or a combination of one layer of conductive particles and one layer of conductive fibers.

A process of embedding the conductive structures 4 in the support plate 2 may be a process in which a carbon fiber bundle is flatly spread into a plane, then the carbon fiber bundle is impregnated in the viscous flow state resin, and the conductive structures 4 are added to the resin, thereby implementing proper electrical improvement of the support plate 2 in a process of spreading and impregnation. In a subsequent process of mold-pressing and forming the support plate 2, the conductive particles or the conductive fibers surround the carbon fiber bundle in the support plate 2 under a pressure of a fixture to form a conductive network, thereby optimizing conductive performance of the support plate 2, and forming a gradient conductive capability on a sectional structure of the support plate 2.

For example, referring to FIG. 4 and FIG. 5, the electronic device further includes a metal layer 5, and the metal layer 5 is disposed on one side of the support plate 2 close to the ultrasonic fingerprint module 3.

For example, the metal layer 5 may be a deposited metal layer obtained through chemical nickel-plating, magnetron sputtering, or electroplating, or the metal layer may be formed by coating a copper foil on the side of the support plate 2 close to the ultrasonic fingerprint module 3. A support structure of the flexible screen that is formed through fitting of the metal layer 5 and the support plate 2 can improve strength and electrical conductivity of the support structure on a basis of ensuring lightweighting of the support structure, thereby effectively improving an electronic grounding requirement of the support plate 2, and ensuring mechanical reliability of the support plate 2.

For example, referring to FIG. 7 to FIG. 9, a hollowed region 51 is disposed in the metal layer 5, and the hollowed region 51 is opposite to the ultrasonic fingerprint module 3.

For example, the hollowed region 51 may be a through hole formed on the metal layer 5. When the ultrasonic fingerprint module 3 transmits an ultrasonic wave toward the side of the flexible screen 1, the ultrasonic wave needs to pass through the metal layer 5 and the support plate 2 before reaching the flexible screen 1. To reduce acoustic resistance of the metal layer 5, windowing may be performed on a region on the metal layer 5 opposite to the ultrasonic fingerprint module 3, that is, the through hole-type hollowed region 51 is formed, to ensure that the ultrasonic wave emitted by the ultrasonic fingerprint module 3 smoothly passes through the metal layer 5.

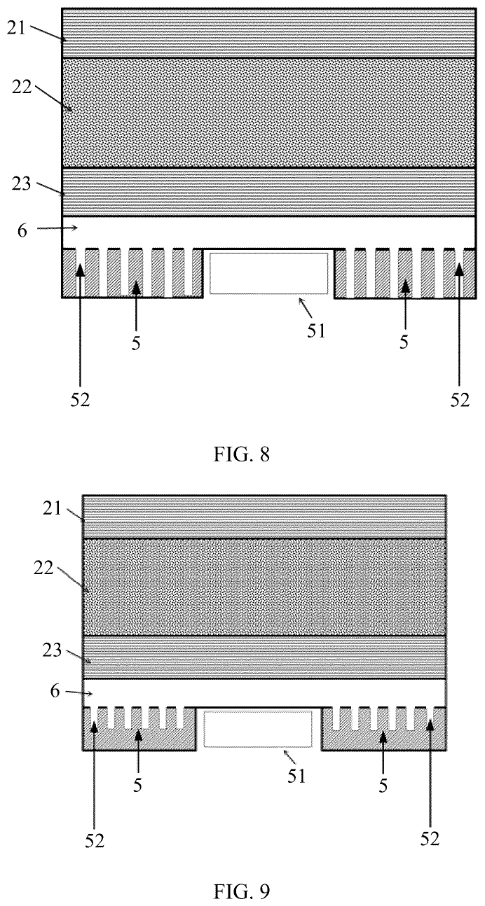

For example, referring to FIG. 8 and FIG. 9, a plurality of hole channels 52 are disposed on the metal layer 5, and the plurality of hole channels 52 are spaced apart and extend along a thickness direction of the metal layer 5.

For example, the metal layer 5 increases a weight of the support structure while ensuring strength and electrical conductivity of the support plate 2. The plurality of hole channels 52 spaced apart and extending along the thickness direction of the metal layer 5, that is, hole channels formed by removing a part of metal from the metal layer 5, may reduce the weight of the metal layer 5, and ensure lightweighting of the electronic device.

For example, referring to FIG. 8 and FIG. 9, at least one of the hole channels 52 is a through hole passing through the metal layer 5; or
at least one of the hole channels 52 is a blind hole embedded in the metal layer 5.

For example, that at least one of the hole channels 52 is a through hole passing through the metal layer 5 may be understood as that some hole channels 52 in the plurality of hole channels 52 are through holes passing through the metal layer 5 and the remaining hole channels 52 are blind holes disposed on the metal layer 5, or the plurality of hole channels 52 are all through holes passing through the metal layer 5. To ensure a weight reduction effect of the metal layer 5, as many hole channels 52 as possible may be disposed as through holes passing through the metal layer 5.

When the hole channels 52 are through holes, flatness of two side surfaces of the metal layer 5 is reduced. To ensure flatness of the surface of the metal layer 5, at least one of the hole channels 52 may be disposed as a blind hole embedded in the metal layer 5. For example, a flat plane is formed on one side of the metal layer 5 close to the ultrasonic fingerprint module 3, and an opening of the blind hole formed by the hole channel 52 faces the support plate 2. That at least one of the hole channels 52 is a blind hole embedded in the metal layer 5 may be understood as that some hole channels 52 in the plurality of hole channels 52 are blind holes embedded in the metal layer 5 and the remaining hole channels 52 are through holes passing through the metal layer 5, or the plurality of hole channels 52 are all blind holes embedded in the metal layer 5.

In addition, the carbon fibers in the support plate 2 may be T-series (high-strength) carbon fibers, M-series (high-modulus) carbon fibers, or MJ-series (high-strength and high-modulus) carbon fibers. To ensure strength and stability of the support plate 2, the M-series carbon fibers may be used to form the support plate 2.

For example, referring to FIG. 8 and FIG. 9, the metal layer 5 is connected to the support plate 2 by using an adhesive layer 6.

The hole channel 52 has an opening facing the support plate 2, and the adhesive layer 6 is filled in the hole channel 52 through the opening.

For example, in a case that the hole channel 52 is a through hole or a blind hole, the hole channel 52 may have an opening facing the support plate 2. When the adhesive layer 6 is disposed between the support plate 2 and the metal layer 5, the adhesive layer 6 in an uncured state may flow into the hole channel 52 through the opening, so that connection strength between the support plate 2 and the metal layer 5 is improved through connection between the adhesive layer 6 and an inner wall of the hole channel 52.

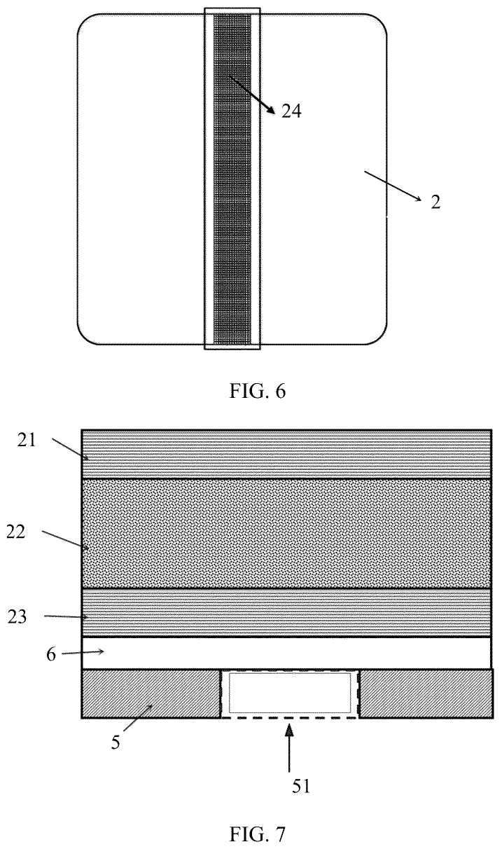

For example, referring to FIG. 6, the flexible screen 1 has a folding region, the support plate 2 has a first through hole region 24, and the metal layer 5 has a second through hole region.

Both the first through hole region 24 and the second through hole region are disposed corresponding to the folding region.

In a process of bending the flexible screen 1, to facilitate bending of the support plate 2 along with the flexible screen 1, the first through hole region 24 may be disposed on the support plate 2. In a case that the metal layer 5 and the support plate 2 are stacked, forming the metal layer 5 on the support plate 2 directly through chemical plating or magnetron sputtering causes brittle fracture of grids in the first through hole region 24.

In this application, the first through hole region 24 is first coated with ink or glue (for example, a long strip-shaped structure that surrounds the first through hole region 24 in FIG. 6). After the ink or the glue is cured, chemical nickel-plating or magnetron sputtering is performed on an entire surface of an ink layer or a glue layer to form the metal layer 5.

For example, a thickness range of the metal layer 5 may be 2 μm to 5 μm. After the metal layer 5 is formed, the ink or the glue on the first through hole region 24 may be removed, and finally, laser puncturing is performed on the metal layer 5 to form the second through hole region. In this way, a problem of fracture of the grids of the first through hole region 24 during formation of the metal layer 5 can be avoided, and thickness uniformity during formation of the metal layer 5 can be ensured.

In addition, the flexible screen 1 may be a flexible screen supporting left-right bending or up-down bending, or may be a flexible screen supporting cross folding, rollable folding, stretchable folding, or the like.

It should be noted that various embodiments in the specification are described in a progressive manner. Each embodiment focuses on the differences from the other embodiments. For the parts that are similar or identical in the embodiments, reference may be made to one another.

Although optional embodiments in embodiments of this application are described, a person skilled in the art may make other changes and modifications to these embodiments once learning of a basic creative concept. Therefore, the appended claims are intended to be construed as including the optional embodiments and all changes and modifications that fall within the scope of embodiments of this application.

Finally, it should be further noted that in the specification, relational terms such as first and second are used only to distinguish one entity from another entity, without necessarily requiring or implying any such actual relationship or order between such entities. In addition, the term “include”, “comprise”, or any other variant thereof is intended to cover a non-exclusive inclusion, so that an article or a terminal device that includes a series of elements not only includes these elements, but also includes other elements that are not expressly listed, or further includes elements inherent to such article or terminal device. An element preceded by “includes a . . . ” further includes, without more constraints, additional identical elements in the article or the terminal device that includes the element.

The foregoing describes the technical solutions provided in this application in detail. Specific examples are used in the specification to describe the principles and implementations of this application. Meanwhile, a person of ordinary skill in the art may change a specific implementation and an application scope according to the principles and implementations of this application. In conclusion, content of the specification should not be construed as a limitation of this application.

1. An electronic device, comprising:
a flexible screen;
a support plate, wherein the support plate is disposed on an inner side of the flexible screen, the support plate comprises a first carbon fiber layer, a second carbon fiber layer, and a third carbon fiber layer that are stacked, and both extension directions of carbon fibers in the first carbon fiber layer and carbon fibers in the third carbon fiber layer are perpendicular to an extension direction of carbon fibers in the second carbon fiber layer; and
an ultrasonic fingerprint module, wherein the ultrasonic fingerprint module is disposed on one side of the support plate away from the flexible screen.

2. The electronic device according to claim 1, wherein a sum of thicknesses of the first carbon fiber layer and the third carbon fiber layer is equal to a thickness of the second carbon fiber layer.

3. The electronic device according to claim 1, wherein the extension direction of the carbon fibers in the first carbon fiber layer is parallel to the extension direction of the carbon fibers in the third carbon fiber layer.

4. The electronic device according to claim 1, further comprising conductive structures, wherein the conductive structures are embedded in at least one of the first carbon fiber layer, the second carbon fiber layer, or the third carbon fiber layer.

5. The electronic device according to claim 1, further comprising a metal layer, wherein the metal layer is disposed on one side of the support plate close to the ultrasonic fingerprint module.

6. The electronic device according to claim 5, wherein a hollowed region is disposed in the metal layer, and the hollowed region is opposite to the ultrasonic fingerprint module.

7. The electronic device according to claim 5, wherein a plurality of hole channels are disposed on the metal layer, and the plurality of hole channels are spaced apart and extend along a thickness direction of the metal layer.

8. The electronic device according to claim 7, wherein at least one of the hole channels is a through hole passing through the metal layer; or
at least one of the hole channels is a blind hole embedded in the metal layer.

9. The electronic device according to claim 7, wherein the metal layer is connected to the support plate by using an adhesive layer; and
the hole channel has an opening facing the support plate, and the adhesive layer is filled in the hole channel through the opening.

10. The electronic device according to claim 5, wherein the flexible screen has a folding region, the support plate has a first through hole region, and the metal layer has a second through hole region; and
both the first through hole region and the second through hole region are disposed corresponding to the folding region.
